(19) United States
(12) Patent Application Publication
(10) Pub. No.: US 2022/0088934 A1
(43) Pub. Date: Mar. 24, 2022

(54) FLUID EJECTION APPARATUS AND METHOD OF CONTROLLING FLUID EJECTION APPARATUS

(71) Applicant: CANON KABUSHIKI KAISHA, Tokyo (JP)

(72) Inventors: Shintaro Kasai, Kanagawa (JP); Yoshinori Misumi, Tokyo (JP); Yuzuru Ishida, Kanagawa (JP)

(21) Appl. No.: 17/468,382

(22) Filed: Sep. 7, 2021

(30) Foreign Application Priority Data
Sep. 18, 2020 (JP) 2020-157214

(51) Int. Cl. B41J 2/17

(52) U.S. Cl. CPC B41J 2/1707

(57) ABSTRACT

A fluid ejection apparatus executes a cleaning process and an ejection operation of ejecting fluid from ejection ports while causing the fluid to flow from a supply port to a fluid collection port of a flow channel provided in a fluid ejection head. Moreover, the fluid ejection apparatus adjusts a flow rate of the fluid flowing in the flow channel to a first flow rate during the ejection operation and adjusts the flow rate of the fluid flowing in the flow channel to a second flow rate higher than the first flow rate at least during the cleaning process.

### BACKGROUND OF THE INVENTION

### Field of the Invention

The present invention relates to a fluid ejection apparatus capable of performing a cleaning process of removing a foreign substance attached to an ejection element of a fluid ejection head and to a control method of the same.

### Description of the Related Art

As a fluid ejection head used in a fluid ejection apparatus such as an inkjet printer, there is known a fluid ejection head that generates bubbles by rapidly heating fluid with heat generated from heat generation resistors forming heating elements and causes the fluid to be ejected from ejection ports with pressure generated with the bubbling. In such a fluid ejection head, there occurs a phenomenon in which additives such as a color material contained in the fluid are decomposed by being heated to high temperature and turn into substances with poor solubility and these substances physically attach to fluid contact portions (insulating layers and protection layers) of the heating elements. Substances (foreign substances) generated by such a phenomenon are generally referred to as “kogation”. Attachment of the kogation to the fluid contact portions of the heating elements causes thermal conduction from heating portions to the fluid to be uneven and makes the bubbling unstable, thereby affecting ejection characteristics of the fluid.

As a technique of solving such a problem, Japanese Patent Laid-Open No. 2008-105364 discloses a configuration in which a coating layer that electrochemically reacts with fluid is arranged on a surface of an insulating layer of each heating element. In this configuration, voltage is applied to the coating layer to cause the coating layer and the fluid to electrochemically react with each other and cause a fluid contact portion to dissolve into the fluid. The kogation attached to a surface portion of the coating layer can be thereby removed (cleaned). However, since the electrochemical reaction between the coating layer and the fluid is used, electrolysis of the fluid in contact with the coating layer occurs and bubbles are generated. In the case where these bubbles accumulate on the coating layer, there is a risk that the bubbles hinder the electrochemical reaction between the coating layer and the fluid and the removal of the kogation is not appropriately performed. Accordingly, in Japanese Patent Laid-Open No. 2008-105364, the kogation cleaning process is performed and then processes such as a suction recovery process of sucking the bubbles from the ejection ports together with the fluid is performed to prevent the hindering of the electrochemical reaction.

Moreover, Published Japanese Translation of PCT International Application No. 2014-510649 discloses a technique in which flow channels communicating with bubbling chambers provided with ejection ports and heating elements are formed in a fluid ejection head and fluid is made to flow in the flow channels and the bubbling chambers to prevent a viscosity increase of the fluid due to evaporation of a solvent component and maintain an ejection performance. The attachment of kogation on the heating elements also occurs in the fluid ejection apparatus in which the fluid is made to flow in the fluid ejection head. Accordingly, as in Japanese Patent Laid-Open No. 2008-105364, a coating layer needs to be provided on each heating element to remove the kogation by means of electrochemical reaction. Moreover, the bubbles generated by the electrolysis of the fluid in the electrochemical reaction need to be discharged from the bubbling chambers and the flow channels.

In the technique disclosed in Published Japanese Translation of PCT International Application No. 2014-510649, a flow rate is set within a range in which the ejection performance can be maintained. This because, if the flow of the fluid in the fluid ejection head is too fast, a negative pressure applied to each ejection port becomes excessively high and there are risks that: fine fluid droplets (mist) are generated together with a main droplet in the fluid ejection; the size of the ejected fluid droplet decreases; and an ejection direction of the fluid deviates. However, at a flow rate within the range in which the ejection performance can be maintained, there is a risk that the bubbles generated by the electrochemical reaction in the removal of kogation cannot be appropriately removed.

### SUMMARY OF THE INVENTION

The present invention is a fluid ejection apparatus comprising: a fluid ejection head including a flow channel that extends from a fluid supply port to a fluid collection port, an ejection port that is used to eject fluid, and an ejection element that heats the fluid flowing into the flow channel to eject the fluid from the ejection port; a cleaning unit that performs a cleaning process by means of electrochemical reaction between the fluid and a fluid contact portion of the ejection element; a fluid flow unit that causes the fluid to flow from the fluid supply port to the fluid collection port of the flow channel in the cleaning process and an ejection operation of ejecting the fluid from the ejection port; and a flow rate control unit that adjusts a flow rate of the fluid flowing in the flow channel to a first flow rate during the ejection operation and adjusts the flow rate of the fluid flowing in the flow channel to a second flow rate higher than the first flow rate at least during the cleaning process.

According to the present invention, it is possible to appropriately perform a cleaning process while maintaining a fluid ejection performance.

Further features of the present invention will become apparent from the following description of exemplary embodiments with reference to the attached drawings.

### BRIEF DESCRIPTION OF THE DRAWINGS

FIG. 1 is an overall view illustrating an inkjet printing apparatus in a first embodiment;

FIGS. 2A and 2B are perspective views of a print head in the first embodiment;

FIG. 3 is a schematic view illustrating a configuration of a fluid flow mechanism in the first embodiment;

FIG. 4 is a schematic view illustrating paths of fluid flowing inside a fluid ejection head;

FIG. 5 is a cross-sectional perspective view of a print element board;

FIG. 6 is an enlarged plan view of a portion surrounded by a broken line in FIG. 5;

FIG. 7 is a cross-sectional view taken along the line VII-VII in FIG. 6;

FIGS. 8A to 8C illustrate states of element cleaning generally performed in a print head;

FIG. 9 is a view illustrating states of height adjustment mechanisms in the case where an element cleaning process is performed;

FIGS. 10A to 10C are cross-sectional views schematically illustrating states of the element cleaning process performed in the embodiment;

FIG. 11 is a block diagram illustrating a schematic configuration of a control system of the printing apparatus in the first embodiment;

FIG. 12 is a flowchart illustrating a series of steps in the case where the element cleaning process is performed;

FIG. 13 is an enlarged plan view schematically illustrating a configuration around the print elements in a second embodiment;

FIG. 14 is a cross-sectional view taken along the line XIV-XIV in FIG. 13;

FIG. 15 is a schematic view illustrating a fluid flow mechanism to the print head in a third embodiment;

FIG. 16 is a schematic view illustrating paths of fluid flowing inside a fluid ejection head in the third embodiment;

FIG. 17 is a schematic view illustrating a modified example of the third embodiment; and

FIGS. 18A and 18B are diagrams illustrating voltage applied between a cavitation resistance layer and an opposing electrode in the element cleaning.

### DESCRIPTION OF THE EMBODIMENTS

A fluid ejection apparatus in embodiments of the present invention is described below with reference to the drawings. Note that the embodiments are described while giving an inkjet printing apparatus that performs printing by ejecting ink being fluid from a fluid ejection head, as an example of the fluid ejection apparatus.

### First Embodiment

### <Inkjet Printing Apparatus>

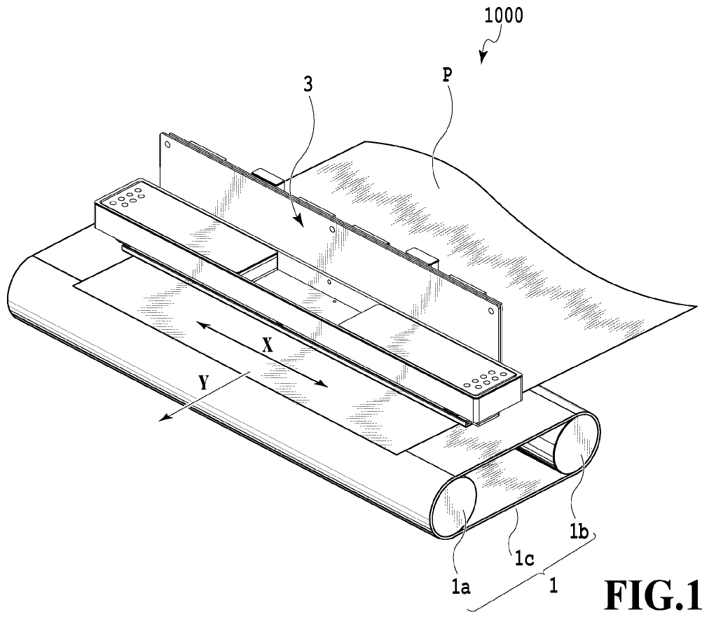

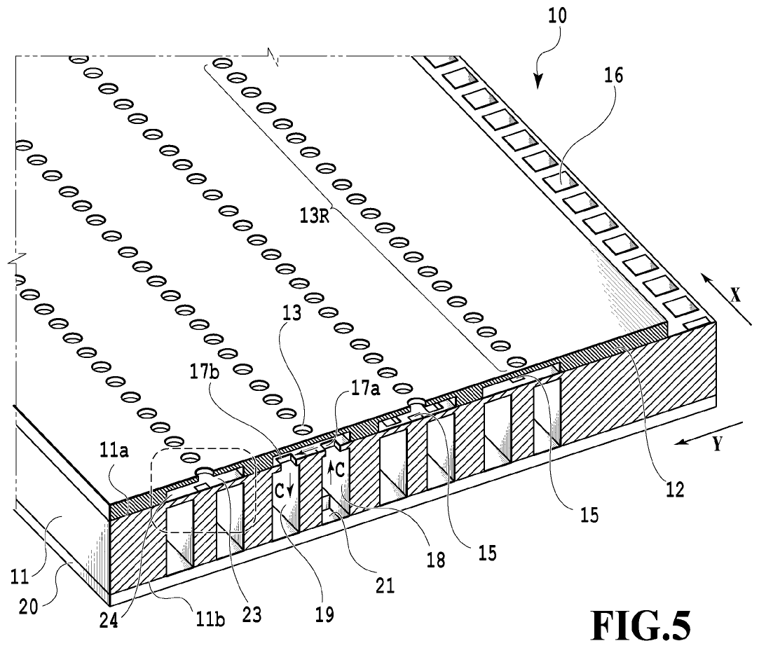

FIG. 1 is a view illustrating a schematic configuration of an inkjet printing apparatus 1000 (hereinafter, referred to as printing apparatus). The printing apparatus 1000 includes a conveyance mechanism 1 that conveys a print medium P and a print head (fluid ejection head) 3 that is an ejection unit configured to eject fluids (inks) to the print medium P. The print head 3 is formed of a line print head that is long and in which multiple ejection ports (see FIG. 5) 13 used to eject the fluids are aligned in a direction (X direction) substantially orthogonal to a conveyance direction (Y direction) of the print medium P. The printing apparatus 1000 is a so-called full-line printing apparatus that continuously performs printing on the print medium P by ejecting the fluids from the ejection ports of the print head 3 while continuously conveying the print medium P.

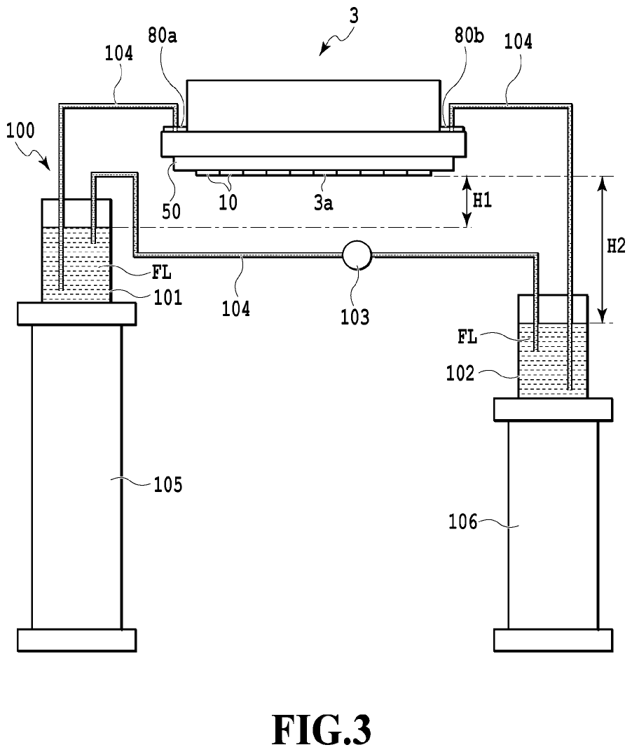

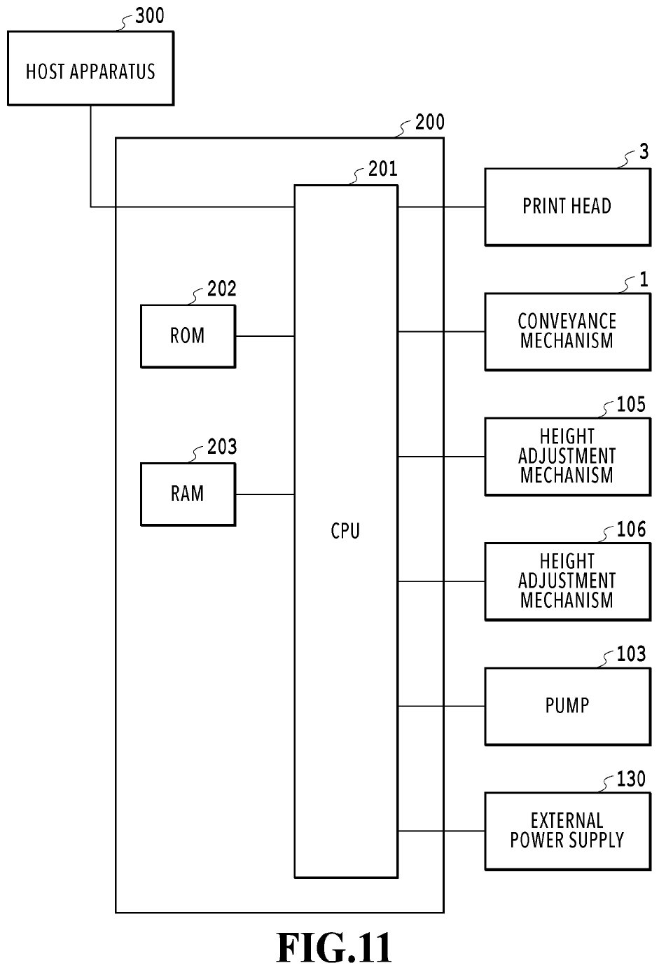

The conveyance mechanism 1 includes paired conveyance rollers 1a and 1b, an endless belt 1c wound around these conveyance rollers, and the like. A cut sheet, a roll sheet, and the like are usable as the print medium P conveyed by the conveyance mechanism 1. The print head 3 is connected to a fluid supply unit (see FIG. 3) to be described later and ejects the fluids supplied from this fluid supply unit from the ejection ports to form an image on the print medium. In the embodiment, there is used the print head 3 capable of performing full color printing by ejecting fluids (hereinafter, also referred to as inks) containing color materials of C, M, Y, and K (cyan, magenta, yellow, and black). Moreover, a controller 200 (see FIG. 11) that supplies power and transmits ejection control signals to the print head 3 is electrically connected to the print head 3.

### <Overall Configuration of Print Head>

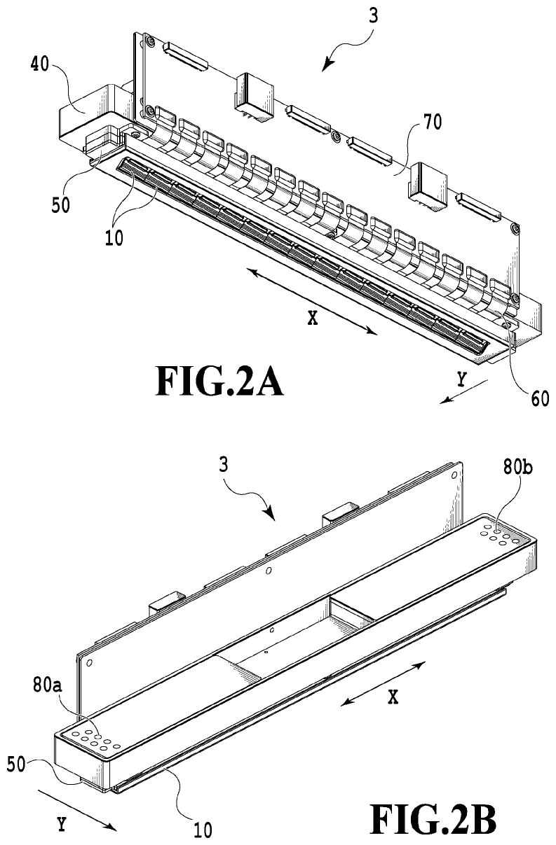

An overall configuration of the print head 3 used in the first embodiment is described. FIGS. 2A and 2B are perspective views of the print head 3 in the embodiment. The print head 3 illustrated in FIGS. 2A and 2B is formed of a line print head 3 in which multiple (15 in this example) print element boards 10 capable of ejecting inks of four colors of C, M, Y, and K are aligned in a straight line. As illustrated in FIG. 2A, an electric wiring board 70 is fixed to a back face of the print head 3 and is electrically connected to the multiple print element boards 10 via flexible wiring boards 60.

As illustrated in FIG. 2B, fluid connection portions 80a and 80b provided respectively in both end portions of the print head 3 are coupled to fluid supply bottles 101 of fluid flow mechanisms 100 (see FIG. 3) to be described later. The inks of the four colors of C, M, Y, and K are thereby supplied from the respective fluid flow mechanisms 100 to the print head 3 and the inks having passed the print head 3 are collected into fluid collection bottles 102 of the fluid flow mechanisms 100. As described above, the embodiment is configured such that the inks (fluids) of the respective colors can be each circulated between the corresponding fluid flow mechanism 100 and the print head 3.

### <Fluid Supply Mechanism>

A configuration of each fluid flow mechanism 100 that causes the fluid to flow in the fluid ejection apparatus of the embodiment is described with reference to a schematic view of FIG. 3. The fluid flow mechanism (fluid flow unit) 100 in the embodiment includes the fluid supply bottle (fluid supply container) 101 that stores the fluid FL to be supplied to the print head 3 and the fluid collection bottle (fluid collection container) that stores the fluid FL having flowed out from the print head 3. The fluid flow mechanism 100 also includes a height adjustment mechanism 105 that moves the fluid supply bottle 101 in the direction of gravity (Z direction) and a height adjustment mechanism 106 that moves the fluid collection bottle 102 in the direction of gravity. Moreover, the fluid flow mechanism 100 includes a return flow channel 114 that allows the fluid FL stored in the fluid collection bottle 102 to be supplied to the fluid supply bottle 101 and a pump 103 provided in the return flow channel 114.

The fluid supply bottle 101 is connected to the fluid connection portion 80a of the print head 3 on the fluid supply side via a tube 104 and the fluid collection bottle 102 is connected to the fluid connection portion 80b of the print head 3 on the fluid collection side via the tube 104. Moreover, the pump 103 is connected to the fluid supply bottle 101 and the fluid collection bottle 102 via the return flow channel 114. A circulation flow channel in which the fluid stored in the fluid supply bottle 101 flows through the print head 3, the fluid collection bottle 102, and the return flow channel 114 and returns to the fluid supply bottle 101 is thereby formed.

The height adjustment mechanism 105 supports the fluid supply bottle 101 and the height adjustment mechanism 106 supports the fluid collection bottle 102. The height adjustment mechanism 105 can adjust a difference between the height of the fluid surface of the fluid FL stored in the fluid supply bottle 101 and the height of a surface (ejection surface) 3a on which the ejection ports 13 in the print element boards 10 are formed, by adjusting the height of the fluid supply bottles 101. Similarly, the height adjustment mechanism 106 can adjust a difference between the height of the fluid surface of the fluid FL stored in the fluid collection bottle 102 and the height of the ejection surface 3a by adjusting the height of the fluid collection bottle 102.

The height adjustment mechanisms 105 and 106 hold the fluid supply bottle 101 and the fluid collection bottle 102 such that the fluid surfaces of the fluid supply bottle 101 and the fluid collection bottle 102 are at positions below the ejection surface 3a of the print head 3. In FIG. 3, the height of the fluid surface in the fluid supply bottle 101 is maintained at a position H1 below the ejection surface 3a and the height of the fluid surface in the fluid collection bottle 102 is maintained at a position H2 below the ejection surface 3a. A relationship between H1 and H2 is H1<H2. Specifically, the fluid surface of the fluid collection bottle 102 is determined to be at a position below the fluid surface of the fluid supply bottle 101.

In the fluid flow mechanism configured as described above, the fluid FL stored in the fluid supply bottle 101 flows through the tube 104 and is supplied from the fluid connection portion 80a to a supply channel of the print head 3. The fluid supplied to the fluid connection portion 80a is partially ejected from the ejection ports 13. Moreover, the fluid FL not used in the ejection is collected from the fluid connection portion 80b into the fluid collection bottle 102 through the tube 104. The pump 103 returns the collected fluid FL to the fluid supply bottle 101 through the return flow channel.

### <Paths of Fluid in Print Head>

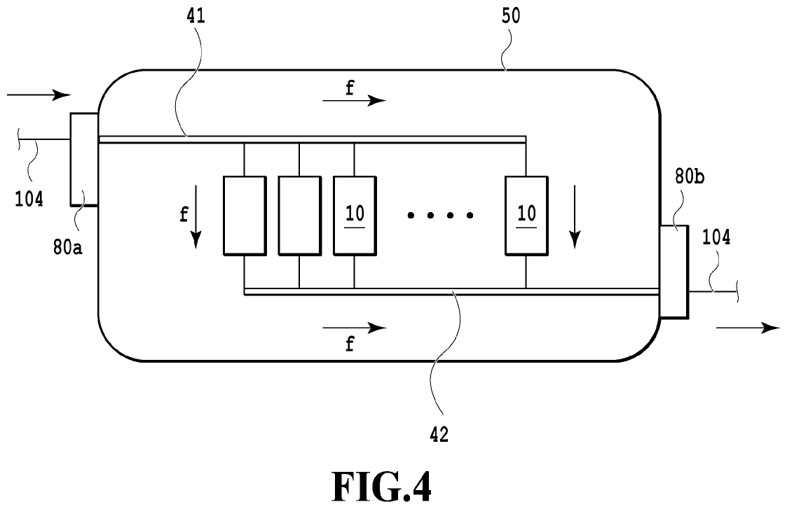

Paths of the fluid FL provided inside the print head 3 are described based on the schematic view of FIG. 4. The arrows f in FIG. 4 illustrate a flow direction of the fluid FL. A supply path 41 and a collection path 42 that communicate with the print element boards 10 are formed in a flow channel member 50 that is a component element of the print head 3. The supply path 41 is connected to the fluid connection portion 80a on the supplied side and supply ports (fluid supply ports) 17a of the print element boards 10. The collection path 42 is connected to collection ports (fluid collection ports) 17b of the print element boards 10 and the fluid connection portion 80b on the collection side.

The fluid FL flowing from the fluid connection portion 80a into the supply path 41 flows into insides of the print element boards 10 from the supply ports 17a of the print element boards 10. The fluid FL flowing into the insides of the print element boards 10 flows out from the collection ports 17b to the collection path 42. In the fluid ejection, the fluid FL flowing into the print element boards 10 is partially ejected from the ejection ports 13 provided in the print element boards 10 and the rest of the fluid FL not used in the ejection flows out to the collection path 42. The fluid FL flowing into the collection path 42 flows out from the fluid connection portion 80b to the tube 104 connected to the fluid connection portion 80b. Note that the flow path of the fluid provided inside the print element boards 10 is described in detail in a structure of each of the print element boards 10 to be described next.

### <Structure of Print Element Board>

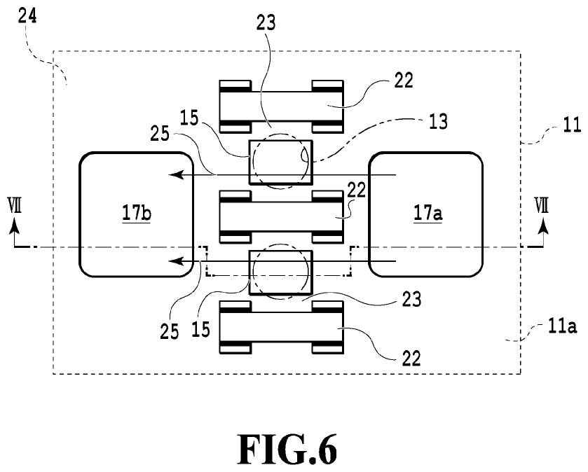

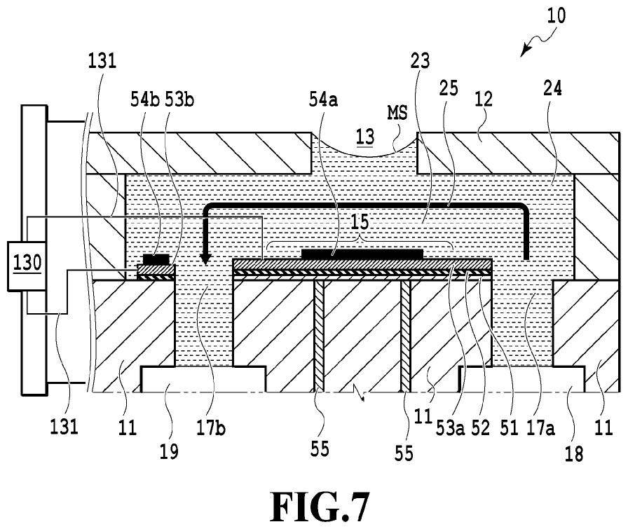

A configuration of each of the print element boards 10 in the embodiment is described with reference to FIGS. 5 to 7. FIG. 5 is a cross-sectional perspective view of the print element board 10. FIG. 6 is an enlarged plan view of a portion surrounded by a broken line in FIG. 5. FIG. 7 is a cross-sectional view taken along the line VII-VII in FIG. 6.

In FIG. 5, the print element board 10 includes a substrate 11 made of silicon, an ejection port formation member 12 stacked on a front face 11a of the substrate 11 and made of a photosensitive resin, and a cover member 20 joined to a back face (face on the opposite side to the face provided with the ejection port formation member 12) 11b of the substrate 11. The multiple ejection ports 13 are aligned at fixed intervals in the X direction in the ejection port formation member 12. Rows formed by the multiple ejection ports 13 arranged in the X direction are referred to as ejection port rows 13R. In the embodiment, since the inks of four colors of CMYK are used as the fluids to be ejected from the ejection ports, four ejection port rows 13R corresponding to the respective ink colors are formed. Note that the Y direction orthogonal to the X direction in which the ejection port rows 13R extend coincides with the conveyance direction (Y direction) of the print medium P illustrated in FIG. 1. Fluid chambers 24 into which the fluids flow are formed between the ejection port formation member 12 and the substrate 11. In the fluid chambers 24, flow channel walls 22 illustrated in FIG. 6 define and form multiple bubbling chambers 23 corresponding to the respective ejection ports 13.

As illustrated in FIG. 6, multiple print elements (ejection elements) 15 are arranged at positions facing the respective ejection ports 13 on the front face 11a of the substrate 11 and one print element 15 is housed in each bubbling chamber 23. Each print element 15 is formed of a heating element that causes bubbling of the fluid by thermal energy. The heating element forming the print element is formed of a thermoelectric conversion element that converts electric energy to thermal energy and is electrically connected to a terminal 16 via not-illustrated electric wiring provided in the substrate 11. The terminal 16 is connected to the electric wiring board 70 via the flexible wiring board 60 illustrated in FIG. 2A and the electric wiring board 70 is connected to a later-described controller provided in the printing apparatus 1000. The print element 15 generates heat based on a pulse signal received from the controller of the printing apparatus 1000 via the electric wiring board 70, the flexible wiring board 60, and the electric wiring and causes the fluid FL in the bubbling chamber 23 to boil. The fluid FL is ejected from the ejection port 13 by force of bubbling in the boiling.

Moreover, as illustrated in FIG. 5, grooves forming fluid supply channels 18 and fluid collection channels 19 communicating with the bubbling chambers 23 are formed on the back face 11b of the substrate 11. The fluid supply channels 18 and the fluid collection channels 19 extend along the ejection port rows 13R. The fluid supply channels 18 communicate with the supply ports 17a and the fluid collection channels 19 communicate with the collection ports 17b. The supply ports 17a and the collection ports 17b communicate with the bubbling chambers 23. Flow channels 25 extending from the supply ports 17a to the collection ports 17b via the bubbling chambers 23 are thereby formed.

The cover member 20 is provided with multiple openings 21 communicating with the fluid supply channels 18 and the fluid collection channels 19 to be described later. In the embodiment, three openings 21 are provided for each fluid supply channel 18 and two openings 21 are provided for each fluid collection channel 19 in the cover member 20. The supply path 41 communicates with the fluid supply channels 18 through the openings 21 and the collection path 42 communicates with the fluid collection channels 19 through the openings 21.

Flow of the fluid in each print element board 10 is described. A pressure difference is generated between each fluid supply channel 18 and the corresponding fluid collection channel 19. This pressure difference causes the fluid in the fluid supply channel 18 provided in the substrate 11 to flow to the fluid collection channel 19 via the supply ports 17a, the bubbling chambers 23, and the collection ports 17b as illustrated by the arrows C in FIG. 5. Generating such flow of the fluid FL allows the fluid (ink) with increased viscosity due to evaporation from the ejection ports 13 to be collected into the fluid collection channel 19 and can also suppress an increase in the viscosity of fluid in the ejection ports 13 and the bubbling chambers 23. The fluid collected into the fluid collection channel 19 is eventually collected into the collection path 42 of the printing apparatus 1000 through the openings 21 in the cover member 20. Such flow of the fluid is referred to as circulation of the fluid.

Next, each of the print elements 15 and the surrounding structures thereof are described in detail with reference to FIG. 7. The print element (ejection element) 15 including a heating layer 51, an insulation layer 52, a kogation removal electrode wiring layer 53a, and a coating layer such as a cavitation resistance layer 54a is provided on the substrate 11. The cavitation resistance layer is a fluid contact portion that comes into direct contact with the fluid in the flow channel 25 and is a heat application portion that applies heat of the heating layer 51 to the fluid. Moreover, vias 55 for power application are formed in the substrate 11 to penetrate the substrate 11 and the heating layer 51 and the controller not illustrated in FIG. 7 are electrically connected to each other through the vias 55. The heating layer 51 is made of materials such as a material that generates heat by being supplied with electricity. For example, the heating layer 51 is made of TaSiN (tantalum silicon nitride), WSiN (tungsten silicon nitride), TaAlN (tantalum aluminum nitride), TiAl (titanium aluminide), TiAlN (titanium aluminum nitride), or the like.

The insulation layer 52 is made of an insulating material such as a silicon compound, for example, a SiN or the like and electrically insulates the fluid FL from the heating layer 51. The cavitation resistance layer 54a is provided to protect the print element 15 from physical impact such as cavitation generated in the case where bubbles generated by boiling of the fluid FL disappear.

Thermal denaturation deposit of a content of the ink generated in the bubbling attaches to the cavitation resistance layer 54a. This is the so-called kogation. The cavitation resistance layer 54a is a layer that dissolves into the fluid FL to remove the kogation in a cleaning process. A metal that dissolves by electrochemical reaction in the fluid FL is used for the cavitation resistance layer 54a. Such a metal include, for example, Ir (iridium), Ru (ruthenium), and the like. The kogation removal electrode wiring layer 53a is formed between the cavitation resistance layer 54a and the insulation layer 52.

The kogation removal electrode wiring layer 53a forms wiring that electrically connects the cavitation resistance layer 54a and an external power supply 130 to each other and is made by using an electrically conductive material. The cavitation resistance layer 54a and the external power supply 130 are electrically connected to each other via the electrode wiring layer 53a. In the embodiment, the external power supply 130 and the electrode wiring layer 53a and the cavitation resistance layer 54a that are a fluid contact portion form a cleaning unit that performs the cleaning process for removing the kogation attached to the print element 15.

An opposing electrode 54b is formed at a position separate from the cavitation resistance layer 54a in the fluid chamber formed between the ejection port formation member 12 and the substrate 11. For example, Ir, Ru, or the like is used for the opposing electrode 54b. The opposing electrode 54b is connected to opposing electrode wiring 53b made of Ta or the like and is connected to the external power supply 130. The opposing electrode 54b is provided, for example, at a position on the opposite side of the collection port 17b to the print element 15

### <Circulation of Fluid in Printing>

Next, description is given of a method of setting a flow rate of each fluid FL supplied into the print head 3 by the fluid flow mechanism 100. The setting of the flow rate of the fluid FL supplied into the print head 3 is performed by setting the height of the fluid surface of the fluid FL stored in the fluid supply bottle 101, the height of the fluid surface of the fluid FL stored in the fluid collection bottle 102, and the height of the ejection ports 13. Specifically, the height difference H1 between the fluid surface of the fluid FL in the fluid supply bottle 101 and the ejection surface (to be more precise, the ejection ports 13) of the print head 3 and the height difference H2 between the fluid surface of the fluid FL in the fluid collection bottle 102 and the ejection ports 13 are set. The relationship between H1 and H2 is H2>H1. A negative pressure applied to the ejection ports 13 is equal to a water head difference of (H1+H2)/2. Meanwhile, a circulation flow rate increases in proportion to a differential pressure (H2−H1).

The pressure of the fluid FL applied to the ejection ports 13, that is the pressure of the fluid FL in the bubbling chambers 23 is set to be a pressure negative to the atmospheric pressure. This is to prevent leakage of the fluid from the ejection ports 13. If the negative pressure applied to the ejection ports 13 is too high, replenishment after the fluid ejection takes more time. In other words, a refill cycle of the fluid FL for the ejection ports 13 becomes longer and high-frequency ejection becomes difficult. Moreover, if the negative pressure is too high, menisci 56 (see FIG. 6) of the fluid FL formed in the ejection ports 13 are greatly recessed and the volume of the ejected fluid decreases. Furthermore, the fluid ejected in the fluid ejection forms a long tail (not illustrated) while flying and this leads to generation of satellites and mist. Moreover, if the negative pressure is excessively high, there is a risk that the menisci are destroyed and the fluid FL cannot be ejected. As described above, it is not preferable to apply excessively high negative pressure to the ejection ports 13.

Accordingly, the negative pressure is normally set within a certain range in consideration of the shape and size of the ejection ports 13 and the surface tension and coefficient of viscosity of the fluid FL to be used. For example, in the case where the physical property values of the fluid FL are such that the coefficient of viscosity is 4 cP and the surface tension is 30 mN/m and the ejection ports 13 have a circular shape with a diameter of 20 the negative pressure applied to the ejection ports 13 is set to about (H1+H2)/2=100 to 300 mmAq. In order to give specific description, the negative pressure is assumed to be (H1+H2)/2=200 mmAq hereinafter.

The circulation flow rate increases in proportion to the differential pressure (H2−H1) as described above. Moreover, the flow rate of the fluid FL in the print head 3 varies depending on the internal structure of the print head 3 and the coefficient of viscosity of the fluid FL. In order to suppress the viscosity increase of the fluid FL near the ejection ports 13, a higher flow rate is preferable. How much flow rate is necessary varies depending on the composition of the fluid FL and the temperature and humidity of the surroundings. In order to increase (H2−H1) while setting the negative pressure applied to the ejection ports 13 to the water head (H1+H2)/2=200 mmAq, it is only necessary to perform at least one of lowering of the fluid collection bottle 102 and lifting of the fluid supply bottle 101. In the embodiment, in order to obtain higher flow rate, the lowering of the fluid collection bottle 102 and the lifting of the fluid supply bottle 101 are performed. Note that it is preferable to avoid the case where the fluid supply bottle 101 is disposed above the ejection ports 13. This is because, if the tube 104 leading to the fluid collection bottle 102 is blocked in the middle, there is a risk that a positive pressure is applied to the ejection ports 13 and the fluid FL leaks out from the ejection ports 13. Accordingly, in the embodiment, for example, H1 is set to 100 mm and H2 is set to 300 mm to achieve the differential pressure (H2−H1)=200 mmAq. For example, assume that the ink flows at 22.5 ml per minute in the print head 3 in this case. A flow amount (flow rate) of the ink in each bubbling chamber 23 is obtained by dividing the flow amount of the ink in the entire print head 3 by the number of bubbling chambers in the entire print head 3 and further dividing the calculated ink flow amount by the cross-sectional area of the bubbling chamber 23 (area of a plane perpendicular to the flow direction). For example, assume that there are 15 print element boards 10 and each print element board 10 includes 12,000 bubbling chambers 23 in the embodiment. Moreover, assume that the cross-sectional area of each bubbling chamber 23 is 100 μm². In this case, the flow rate of the fluid FL in the bubbling chamber 23 is about 20 mm/s.

### <Cleaning Method>

The kogation is gradually deposited on the surface of each print element 15 (more specifically, on the surface of the cavitation resistance layer 54a) with an increase in the accumulated number of ejection operations of the fluid FL from the ejection port 13. In the case where the kogation is deposited on the surface of the print element 15, the thermal energy propagating from the print element 15 to the fluid in the bubbling chamber 23 decreases to cause a decrease in the intensity of the bubbling and the flying speed and ejection amount of the droplet-shaped fluid (fluid droplet) ejected from the ejection port 13 decrease. This leads to a decrease in the print quality. Accordingly, in the embodiment, in the case where the accumulated number of ejection operations of the fluid FL reaches a predetermined value, the ejection of the fluid FL is temporarily stopped and cleaning (hereinafter, referred to as element cleaning) for removing the kogation deposited on the surface of the print element 15 (surface of the cavitation resistance layer 54a) is performed.

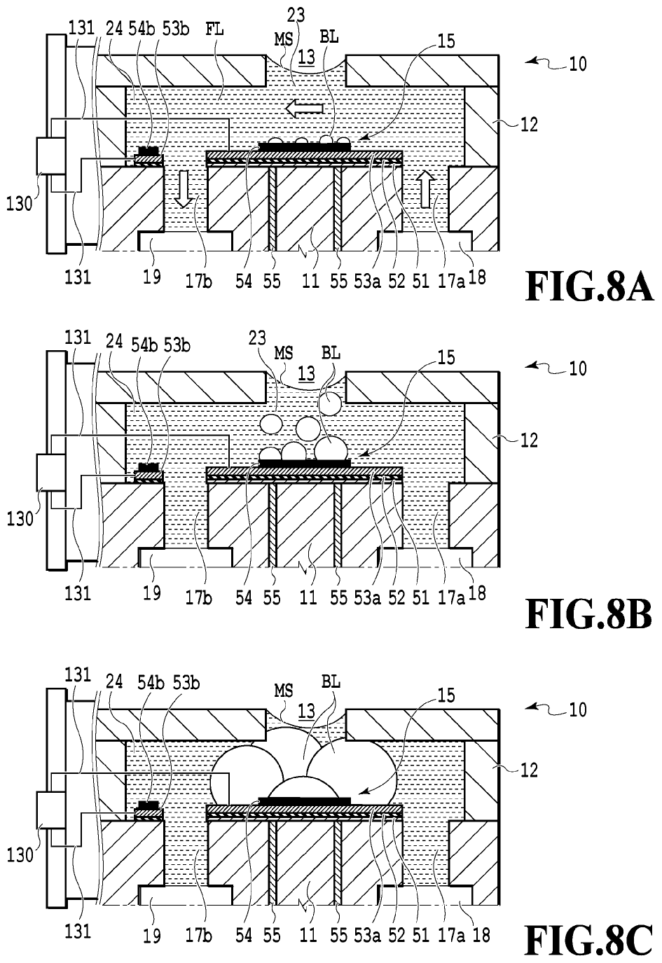

FIGS. 8A to 8C are views illustrating states of the element cleaning generally performed in the print head 3. Note that the white arrows illustrated in FIGS. 8A to 8C schematically illustrate how the fluid FL flows. As illustrated in FIG. 8A, the element cleaning is performed by applying voltage between the cavitation resistance layer 54a and the opposing electrode 54b with the bubbling chamber 23 filled with the fluid FL. For example, a positive potential is applied to the cavitation resistance layer 54a and a negative potential is applied to the opposing electrode 54b. A potential difference (voltage) between the cavitation resistance layer 54a and the opposing electrode 54b is, for example, 5 V. Applying the voltage between the cavitation resistance layer 54a and the opposing electrode 54b causes the electrochemical reaction to occur between cavitation resistance layer 54a and the fluid FL and part (surface portion) of the cavitation resistance layer 54a dissolves into the fluid. The kogation deposited on the surface of the cavitation resistance layer 54a thereby peels off from the cavitation resistance layer 54a together with the surface portion of the cavitation resistance layer 54a dissolving into the fluid and is discharged to the outside of the print head 3 together with the circulating fluid.

Meanwhile, this electrochemical reaction causes electrolysis of the fluid FL on the surface of the cavitation resistance layer 54a. As a result, as illustrated in FIG. 8A, multiple bubbles BL are generated on the surface of the cavitation resistance layer 54a. These bubbles BL grow by uniting with one another as illustrated in FIG. 8B and fill the entire bubbling chamber 23 to cover the print element 15 as illustrated in FIG. 8C. In such a situation, the cavitation resistance layer 54a and the fluid FL are out of contact and the electrochemical reaction is less likely to further progress. Specifically, the removal of the kogation is less likely to progress. Moreover, the fluid FL cannot be ejected from the ejection port 13 in the state where the bubbling chamber 23 is filled with bubbles. Specifically, the ejection of the fluid FL cannot be resumed after the completion of the element cleaning until the bubbles filling the bubbling chamber 23 are removed therefrom.

Accordingly, in the embodiment, the flow rate of the fluid in the flow channels from the supply ports 17a to the collection ports 17b in the print element boards 10 of the print head 3 is increased prior to the execution of the kogation removal process to suppress filling of the bubbling chambers 23 with the bubbles BL. The kogation removal process can be thereby promoted and there is no need to perform a process for removing the bubbles before resuming of the ejection operation of the fluid FL.

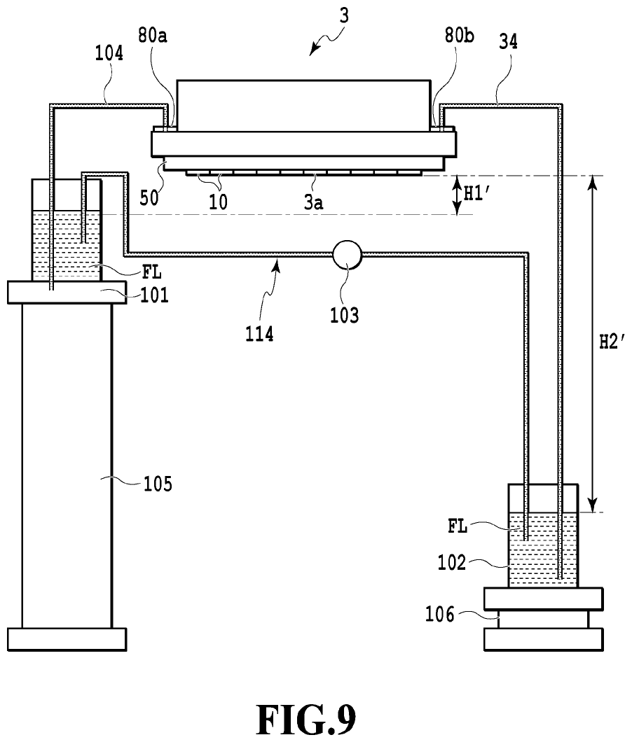

Specifically, the element cleaning is performed in the following steps. First, in the case where the number of the ejection operations of the fluid FL reaches a predetermined number, the ejection operation of the fluid FL is halted. Then, the flow rate of the fluid FL in the print head 3 is increased. This is performed by adjusting the heights (positions in the direction of gravity) of the fluid supply bottle 101 and the fluid collection bottle 102 with the height adjustment mechanisms 105 and 106 as illustrated in FIG. 9. Specifically, the height difference between the fluid surface in the fluid supply bottle 101 and the ejection surface 3a held at the fixed height in the direction of gravity and the height difference between the fluid surface in the fluid collection bottle 102 and the ejection surface 3a are adjusted.

For example, the height difference between the fluid surface of the fluid supply bottle 101 and the ejection surface 3a in the ejection operation is referred to as H1 and the height difference between the fluid surface of the fluid collection bottle 102 and the ejection surface 3a in the ejection operation is referred to as H2 (see FIG. 3). Meanwhile, in the case where the element cleaning is executed, the height of the fluid supply bottle 101 is raised from the position illustrated in FIG. 3 to the position illustrated in FIG. 9 to reduce the height difference between the fluid surface of the fluid supply bottle 101 and the ejection surface 3a to H1′ (H1′<H1). Moreover, the fluid collection bottle 102 is lowered from the position illustrated in FIG. 3 to the position illustrated in FIG. 9 to increase the height difference between the fluid surface of the fluid collection bottle 102 and the ejection surface 3a to H2′ (H2′>H2). Note that, since the ejection of the fluid FL from the ejection ports 13 is halted in the case where the element cleaning is performed, the aforementioned constraints regarding the setting of the negative pressure that are required in the ejection of the fluid FL are alleviated. Specifically, the negative pressure does not have to be set in consideration of the volume decrease of the ejected fluid droplets and the generation of mist and can be increased within such a range that the meniscus in each ejection port 13 does not break.

Accordingly, in the embodiment, for example, H1′ and H2′ are set such that H1′=50 to 100 mm

H2′=700 to 900 mm.

In other words, the negative pressure (H1′+H2′)/2 applied to the ejection port 13 is set to

(H1′+H2′)/2=375 to 500 mmAq.

Moreover, the differential pressure (H2′−H1′) is set to (H2′−H1′)=600 to 850 mmAq.

The meniscus does not break in the case where the negative pressure in the bubbling chamber 23 is maintained in the range of 400 to 500 mmAq. Moreover, the flow rate (second flow rate) of the fluid FL in the element cleaning is 3 to 4.25 times the flow rate (first flow rate) of the fluid FL in the ejection. Accordingly, the flow rate (second flow rate) of the fluid FL in the bubbling chamber 23 is about 60 to 85 mm/s.

A greater height difference may be provided between the fluid surface of the fluid supply bottle 101 and the fluid surface of the fluid collection bottle 102 by setting the position of the fluid supply bottle 101 such that the fluid surface of the fluid supply bottle 101 is located above the ejection ports 13 in the vertical direction. Even larger differential pressure can be generated in this case and the flow rate of the fluid FL can be further increased. For example, H1′ and H2′ are set such that H1′=−150 mm (position above the ejection ports 13) and H2′=850 mm. Specifically, the negative pressure and the differential pressure are set such that negative pressure (H1′+H2′)/2=350 mmAq and differential pressure (H2′−H1′)=1000 mmAq. The meniscus does not break at the negative pressure of 350 mmAq. Assuming that the diameter of the ejection port 13 is the meniscus breaks in the case where the negative pressure of about 600 mmAq is generated. Accordingly, the negative pressure needs to be set such that negative pressure (H1′+H2′)/2<600 mmAq. In this case, the flow rate (second flow rate) of the fluid FL in the bubbling chamber 23 is about five times the flow rate (first flow rate) of the fluid FL in the case where the ejection operation is performed. Specifically, the flow rate in the bubbling chamber 23 is about 100 mm/s.

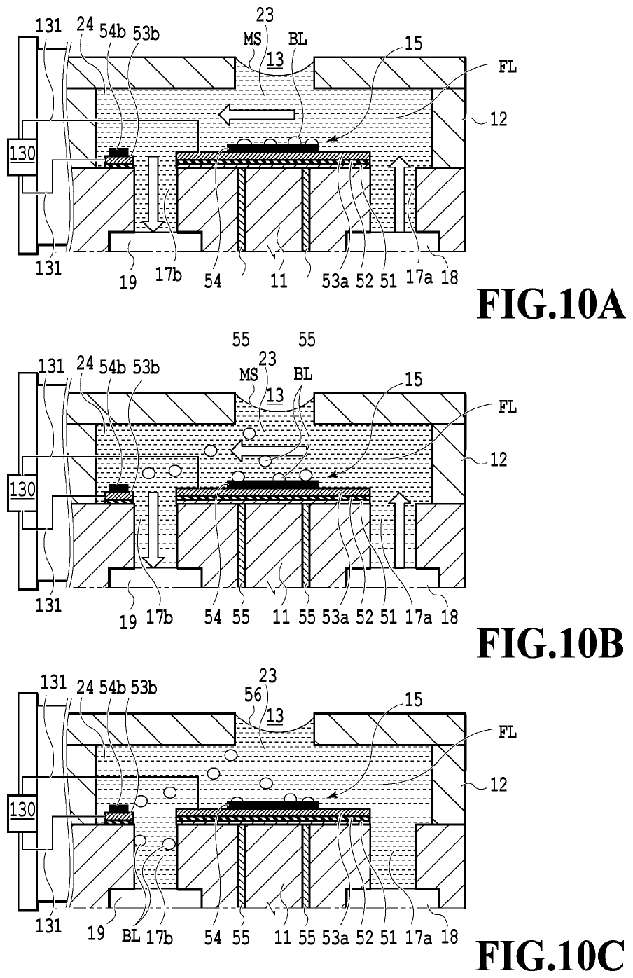

FIGS. 10A to 10C are cross-sectional views schematically illustrating states of the element cleaning process performed in the embodiment. The white arrows in FIGS. 10A to 10C schematically illustrate states of flow caused by the circulation of the fluid FL. In the case where the element cleaning (kogation removal process) is performed, electrolysis of the fluid FL occurs on the surface of the cavitation resistance layer 54a as described above. As a result, as illustrated in FIG. 10A, multiple bubbles BL are generated on the surface of the cavitation resistance layer 54a. However, in the embodiment, as illustrated in FIGS. 10A to 10C, the bubbles generated on the surface of the cavitation resistance layer 54a move to the collection port 17b together with the circulation flow of the fluid FL before the uniting and growing of the bubbles BL occur, and are discharged to the outside of the print head 3. Accordingly, filling of the bubbling chamber 23 with the bubbles is suppressed and the contact between the cavitation resistance layer 54a and the fluid FL is maintained. Thus, it is possible to cause the electrochemical reaction to continuously occur and appropriately perform the element cleaning. Moreover, since the bubbles do not accumulate in the bubbling chamber 23, there is no need to perform the process of removing the bubbles from the bubbling chamber 23 in the case where the ejection of the fluid FL is to be resumed after the completion of the element cleaning. Accordingly, it is possible to quickly resume the ejection of the fluid droplet by returning the heights of the fluid supply bottles 101 and the fluid collection bottles 102 to the positions illustrated in FIG. 3 again after the completion of the element cleaning.

### (Control System of Printing Apparatus)

FIG. 11 is a block diagram illustrating a schematic configuration of a control system of the printing apparatus 1000 in the embodiment. The printing apparatus 1000 is provided with the controller 200 that controls a printing operation based on image data and the like received from a host apparatus 300. The controller 200 includes a central processing unit (CPU) 201, a read-only memory (ROM) 202 that stores a control program and the like, a random access memory (RAM) 203 that temporarily stores data, and the like. The CPU 201 performs various computation processes according to the program stored in the ROM 202 while using the RAM 203 as a work area and also functions as a control unit that controls operations of various units in the printing apparatus 1000. For example, the CPU 201 controls a head driver that drives the print elements 15, based on the image data sent from the host apparatus 300 and controls the ejection of the fluid. Moreover, the CPU 201 controls a not-illustrated conveyance motor in the conveyance mechanism 1 to control rotation of the conveyance roller la and controls a conveyance operation of the print medium P and the like. Furthermore, the CPU 201 controls a not-illustrated adjustment motor that is a drive source of the aforementioned height adjustment mechanisms 105 and 106 to independently control the heights of the fluid supply bottle 101 and the fluid collection bottle 102. In the embodiment, the CPU 201 and the height adjustment mechanisms 105 and 106 form a flow rate control unit that controls the flow rate of the fluid in the print head 3. Moreover, the CPU 201 controls the external power supply 130 to supply and block voltage applied between the kogation removal electrode wiring layers 53a and the opposing electrodes 54b. Furthermore, the CPU 201 controls the drive of the pump 103 to control supply of the fluid from the fluid collection bottle 102 to the fluid supply bottle 101.

### <Steps of Element Cleaning>

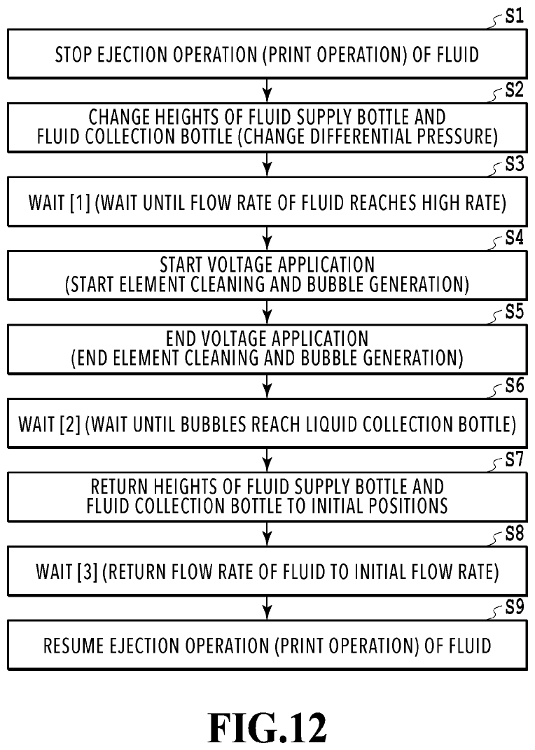

FIG. 12 is a flowchart illustrating a series of steps in the case where the element cleaning process of removing the kogation deposited on the print elements 15 is performed. The CPU 201 provided in the controller 200 performs the steps in this flowchart by controlling the various units in the printing apparatus 1000 according to the control program stored in the ROM 201. Specifically, the CPU 201 performs the element cleaning process by controlling the print head 3, the external power supply 130, the height adjustment mechanisms 105 and 106, the pump 103, and the like. Note that reference sign S attached to each step number in the flowchart of FIG. 12 means step.

In FIG. 12, in the case where the accumulated number of ejection operations of the fluid reaches the predetermined number, the CPU 201 performs an ejection stop step of stopping the ejection operation (print operation) of the fluid from the print head 3 (S1). Next, in order to increase the flow rate of the fluid in the print head 3, the CPU 201 controls the height adjustment mechanisms 105 and 106 and changes the heights of the fluid supply bottle 101 and the fluid collection bottle 102 (S2). Specifically, the CPU 201 controls the height adjustment mechanism 105 and 106 such that they lift the fluid supply bottle 101 and lower the fluid collection bottle 102. The differential pressure thereby increases from (H2−H1) to (H2′−H1′). Note that, since there is a time difference of one to several seconds between the changing of the heights of the bottles 101 and 102 and the changing of the flow rate of the fluid FL in the print head 3, the CPU 201 waits in S3 until time equal to or longer than this time difference elapses (wait [1]).

Then, in S4, the CPU 201 starts application of voltage between the cavitation resistance layers 54a and the opposing electrodes 54b. In the case where the voltage application is started, the electrochemical reaction immediately starts and the element cleaning is started. In the element cleaning, the voltage needs to be continuously applied for predetermined time. After a lapse of the predetermined time, the CPU 201 ends the voltage application (S5). The voltage application time is set to, for example, about 30 seconds. The high flow rate is maintained for predetermined time also after the completion of the voltage application. The bubbles BL generated in the bubbling chambers 23 flows from the bubbling chambers 23 to the fluid collection channel 19 together with the flowing fluid FL. It is not preferable that the bubbles BL remain in the interior of the print head 3 such as the fluid collection channel 19. Accordingly, in S5, the CPU 201 waits for predetermined time (for example, three minutes) while maintaining the flow rate of the fluid FL at the high flow rate (second flow rate) until the bubbles BL reach the fluid collection bottle 102 (wait [2]). Waiting time in the wait [2] is preferably set to time longer than that in the wait [1] as described above. Then, the CPU 201 controls the height adjustment mechanisms 105 and 106 and returns the fluid supply bottle 101 and the fluid collection bottle 102 to initial positions set in the fluid ejection. Specifically, the CPU 201 returns the differential pressure from (H2′−H1′) to (H2−H1) (S7). The CPU 201 waits for predetermined time (several seconds) again (wait [3]) and causes the flow rate of the fluid to return to the initial flow rate (first flow rate) suitable for the fluid ejection (S8). Thereafter, the CPU 201 drives the print elements 15 of the print head 3 and resumes the fluid ejection operation (print operation).

As described above, in the embodiment, in the case where the element cleaning of removing the kogation deposited on the print elements 15 is performed, the heights of the fluid supply bottle 101 and the fluid collection bottle 102 are changed to increase the flow rate of the fluid in the print head 3. This allows the bubbles generated on the print elements 15 in the element cleaning to be discharged to the outside of the print head 3 together with the fluid and the kogation deposited on the print elements 15 can be appropriately removed.

Moreover, in the embodiment, the fluid does not have to be discharged from the ejection ports to discharge the bubbles generated in the element cleaning from the print head 3. Specifically, there is no need to perform a suction process of sucking the fluid from the ejection ports, a pressure application process of applying pressure to the inside of the fluid ejection head to discharge the fluid, or a process of ejecting the fluid that does not contribute to printing on the print medium as in the conventional techniques. Thus, according to the embodiment, it is possible to suppress consumption of the fluid and the print medium that do not contribute to the print operation and achieve running cost reduction and improved efficiency of the print operation.

### Second Embodiment

Next, a second embodiment of the present invention is described. A fluid ejection apparatus in the embodiment achieves the flow rate increase of the fluid performed in the case where the element cleaning is performed, by increasing the temperature of the fluid and reducing the viscosity of the fluid. Note that, also in this embodiment, the fluid ejection apparatus has the configurations illustrated in FIGS. 1, 2A, 2B, 4, and 5. The same parts as those in the aforementioned first embodiment are denoted by the same reference numerals and overlapping description is omitted.

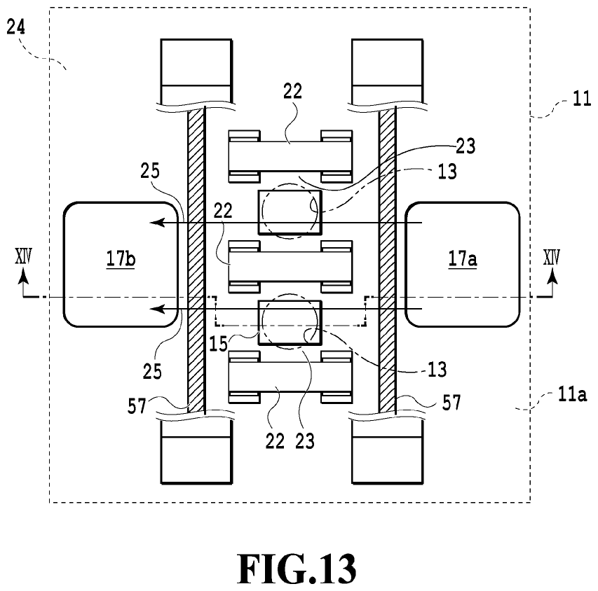

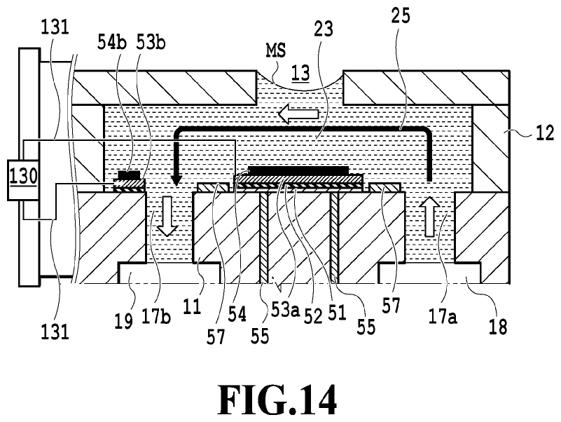

FIG. 13 is a view illustrating a configuration around the print elements 15 in the embodiment and is an enlarged plan view of a portion surrounded by the broken line in the print element board 10 illustrated in FIG. 5. FIG. 14 is a cross-sectional view taken along the line XIV-XIV in FIG. 13. Second heating layers 57 are provided on the front face 11a of the substrate 11 provided in each print element board 10 in the embodiment. The second heating layers 57 are formed of films made of, for example, TaSiN (tantalum silicon nitride) or Poly-Si (poly-silicon). The temperature of the entire print element board 10 can be increased by applying a direct current or a pulse-shaped voltage to the second heating layers 57 and causing the second heating layers 57 to generate heat. A controller controls a not-illustrated second external power supply to apply the voltage to the second heating layers 57. Note that, also in this embodiment, the controller that controls the various units of the printing apparatus 1000 such as the second external power supply has a configuration including the CPU 201, the ROM 202, the RAM 203, and the like as illustrated in FIG. 11. In the embodiment, the CPU 201 and the second heating layers 57 controlled by the CPU 201 form the flow rate control unit that controls the flow rate of the fluid FL flowing in the flow channels 25 of the print element board 10.

In the fluid ejection, the CPU 201 does not apply the voltage to the second heating layers 57 and maintains the temperature of the fluid FL at room temperature (for example 25° C.). The viscosity of the fluid FL in this case is, for example, 5×10⁻³Pa·s (pascal second). Meanwhile, in the case where the element cleaning is performed, the CPU 201 stops the fluid ejection operation and then applies the voltage of the second external power supply to the second heating layers 57 to adjust the temperature of the print element board 10 to 70° C. The CPU 201 can adjust the temperature by controlling and setting the voltage applied to the second heating layers 57, time of voltage application, a pulse number, or the like to a predetermined value. Moreover, an output from a not-illustrated temperature sensor provided in the print element board 10 can be fed back to the CPU 201 to allow the CPU 201 to adjust the temperature of the print element board 10 to the predetermined temperature.

The increase in the temperature of the print element board 10 heats the fluid FL flowing inside the print element board 10 to substantially the same temperature as the print element board 10 as illustrated in FIG. 14 and the viscosity of the fluid FL thereby decreases from that at the room temperature. For example, assume that the viscosity of the fluid FL heated to 70° C. is 2×10⁻³ Pa·s (pascal second). In this case, the flow rate (second flow rate) of the fluid FL flowing in the print element board 10 increases to 2.5 times the flow rate (first flow rate) in the fluid ejection (at the room temperature). Then, the element cleaning is executed and the circulation flow with an increased flow rate can thereby discharge the bubbles generated on the cavitation resistance layers 54a to the outside of the print head 3 and suppress filling of the bubbling chambers 23 with the bubbles BL. Accordingly, the kogation can be appropriately removed from the print elements 15 also in this embodiment. Moreover, according to this embodiment, there is no need to adjust the heights of the fluid supply bottle 101 and the fluid collection bottle 102 in the case where the element cleaning is performed. In other words, the height adjustment mechanisms 105 and 106 provided in the first embodiment are unnecessary and the size reduction and cost reduction of the apparatus can be achieved.

### Third Embodiment

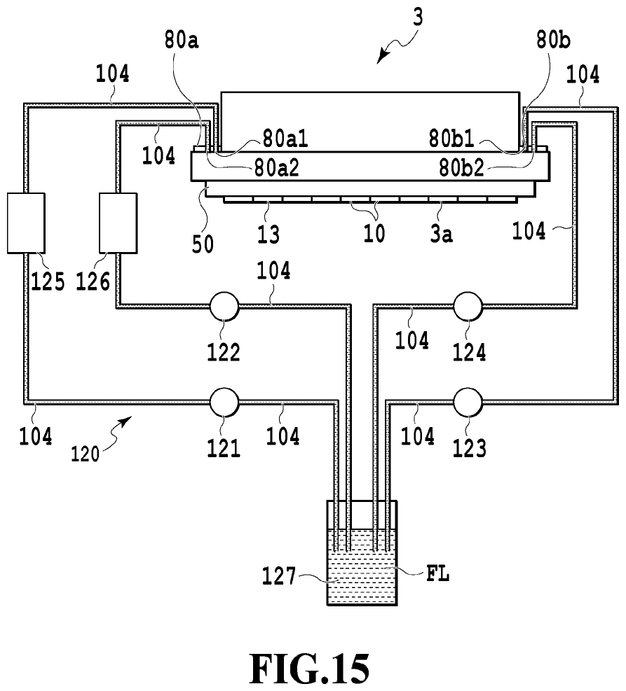

Next, a third embodiment of the present invention is described. FIG. 15 is a schematic view illustrating a fluid flow mechanism 120 to the print head 3 in the embodiment. The fluid flow mechanism 120 in the embodiment includes a fluid supply collection bottle (fluid supply collection container) 127, a first upstream pump 121, a second upstream pump 122, a first regulator 125, a second regulator 126, a first downstream pump 123, a second downstream pump 124, and the like. The fluid supply collection bottle 127 is connected to the fluid connection portion 80a on the fluid supply side of the print head 3 and the fluid connection portion 80b on the fluid collection side of the print head 3, and stores the fluid (ink) FL to be supplied to the print head 3 as well as the fluid FL collected from the print head 3.

The connection state of the fluid supply collection bottle 127 and the print head 3 is described more specifically. The fluid supply collection bottle 127 is connected to the first upstream pump 121 via the tube 104 and the first upstream pump 121 is connected to the first regulator (pressure adjustment mechanism) 125 via the tube 104. Moreover, the first regulator 125 is connected to a first inlet port 80a 1 of the fluid connection portion 80a in the print head 3 via the tube 104.

Moreover, the fluid supply collection bottle 127 is connected to the second upstream pump 122 via the tube 104 and the second upstream pump 122 is connected to the second regulator (pressure adjustment mechanism) 126 via the tube 104. Furthermore, the second regulator 126 is connected to a second inlet port 80a2 of the fluid connection portion 80a in the print head 3 via the tube 104.

Meanwhile, the fluid supply collection bottle 127 is connected to the first downstream pump 123 via the tube 104 and the first downstream pump 123 is connected to a first outlet port 80b 1 of the fluid connection portion 80b in the print head 3 via the tube 104. Moreover, the fluid supply collection bottle 127 is connected to the second downstream pump 124 via the tube 104 and the second downstream pump 124 is connected to a second outlet port 80b2 of the fluid connection portion 80b in the print head 3 via the tube 104.

In the fluid flow mechanism 120 configured as described above, the first upstream pump 121 supplies the fluid FL stored in the fluid supply collection bottle 127 to the first inlet port 80a 1 of the fluid connection portion 80a via the first regulator 125. Similarly, the second upstream pump 122 supplies the fluid FL stored in the fluid supply collection bottle 127 to the second inlet port 80a2 of the fluid connection portion 80a via the second regulator 126. In this case, the first regulator 125 and the second regulator 126 adjust the pressures of the fluid FL supplied to the first inlet port 80a1 and the second inlet port 80a2 to pressures set in advance, respectively. Note that the first regulator 125 and the second regulator 126 are formed of general depressurization valves including, for example, diaphragms and adjustment springs. Note that the first regulator 125, the second regulator 126, and the CPU 201 form the flow rate control unit in the embodiment.

The fluid FL supplied to the first inlet port 80a1 and the second inlet port 80a 2 passes through later-described paths provided in the print head 3 and flows to the outside of the print head 3 from the first outlet port 80b1 and the second outlet port 80b2 of the fluid connection portion 80b. The fluid FL flowing out from the first outlet port 80b1 is sent to the fluid supply collection bottle 127 via the tube 104 by the first downstream pump 123 and is collected. Similarly, the fluid FL flowing out from the second outlet port 80b2 is sent to the fluid supply collection bottle 127 via the tube 104 by the second downstream pump 124 and is collected.

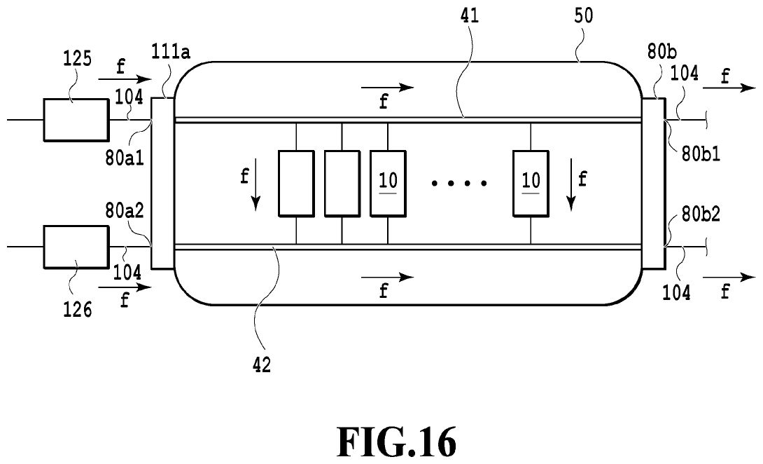

FIG. 16 is a view schematically illustrating the paths of the fluid flowing inside the print head 3 in the embodiment. The arrows fin FIG. 16 illustrate the flow direction of the fluid. In the embodiment, the supply path 41 and the collection path 42 communicating with the print element boards 10 are formed in the flow channel member 50 that is the component element of the print head 3. The supply path 41 is connected to the first inlet port 80a1 of the fluid connection portion 80b on the supply side, the supply ports 17a of the respective print element boards 10, and the first outlet port 80b 1 of the fluid connection portion 80b on the collection side. Moreover, the collection path 42 is connected to the second inlet port 80a2 of the fluid connection portion 80a on the supply side, the collection ports 17b of the respective print element boards 10, and the second outlet port 80b2 of the fluid connection portion 80b on the collection side. Note that the print element boards 10 in the embodiment have the internal configuration illustrated in FIG. 5 as in the first embodiment.

The fluid supplied to the first inlet port 80a1 of the fluid connection portion 80a through the first regulator 125 flows into the supply path 41. Part of the fluid flowing into the supply path 41 is divided to flow to the supply ports 17a of the respective print element boards 10 and the rest of the fluid flows through the first outlet port 80b1 of the fluid connection portion 80b out to the tube 104 connected to the outside. Moreover, the fluid supplied to the second inlet port 80a2 of the fluid connection portion 80a through the second regulator 126 flows into the collection path 42. The fluid flowing into the collection path 42 merges with the fluid flowing out from the collection ports 17b of the respective print element boards 10 and then flows through the second outlet port 80b2 of the fluid connection portion 80b out to the tube 104 connected to the outside. In this case, the inner pressures of the supply path 41 and the collection path 42 are set to negative pressures by appropriately adjusting the pumps 121 to 124 and the regulators 125 and 126 illustrated in FIG. 15 to set the pressures applied to the ejection ports 13 to negative pressures. Moreover, the negative pressure in the collection path 42 is set to a higher negative pressure than the negative pressure in the supply path 41 to generate a differential pressure between the supply path 41 and the collection path 42. For example, in the case where the fluid is ejected, the negative pressure in the supply path 41 is set to 100 mmAq and the negative pressure in the collection path 42 is set to 300 mmAq. This allows the fluid to be ejected from the ejection ports 13 of the print element boards 10 while allowing the fluid to flow from the supply ports 17a to the collection ports 17b of the print element boards 10. Specifically, it is possible to generate flow of the fluid sequentially passing through the fluid supply channels 18, the bubbling chambers 23, and the fluid collection channels 19 illustrated in FIG. 5.

Moreover, in the case where the element cleaning is to be performed, the first regulator 125 and the second regulator 126 adjust the pressures of the fluid flowing into the supply path 41 and the collection path 42. For example, the negative pressure inside the supply path 41 is set to −50 mmAq and the negative pressure inside the collection path 42 is set to −850 mmAq to make the pressure difference between the supply path 41 and the collection path 42 greater than the pressure difference in the fluid ejection. This pressure adjustment is performed by adjusting the not-illustrated pressure adjustment springs provided in the respective regulators 125 and 126.

Adjusting the pressures of the fluid flowing into the supply path 41 and the collection path 42 as described above can increase the flow rate of the fluid flowing in the print element boards 10 in the element cleaning. The high-rate flow of the fluid can thus cause the bubbles generated on the print elements 15 to flow out from the print element boards 10 and suppress filling of the bubbling chambers 23 with the bubbles BL. In other words, the kogation can be appropriately removed from the print elements 15 also in this embodiment.

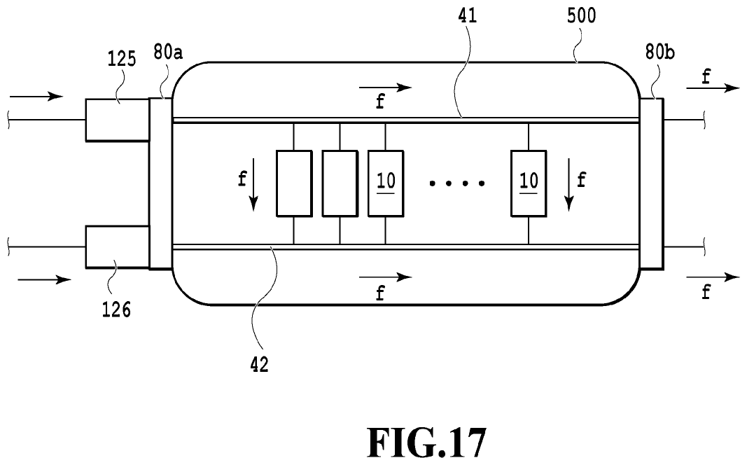

Note that, although the regulators 125 and 126 separate from the print head are connected to the print head 3 via the tubes 104 in the embodiment, the installation mode of the regulators is not limited to this. For example, as illustrated in the modified example of FIG. 17, the regulators 125 and 126 may be installed integrally with the print head 3.

### Fourth Embodiment

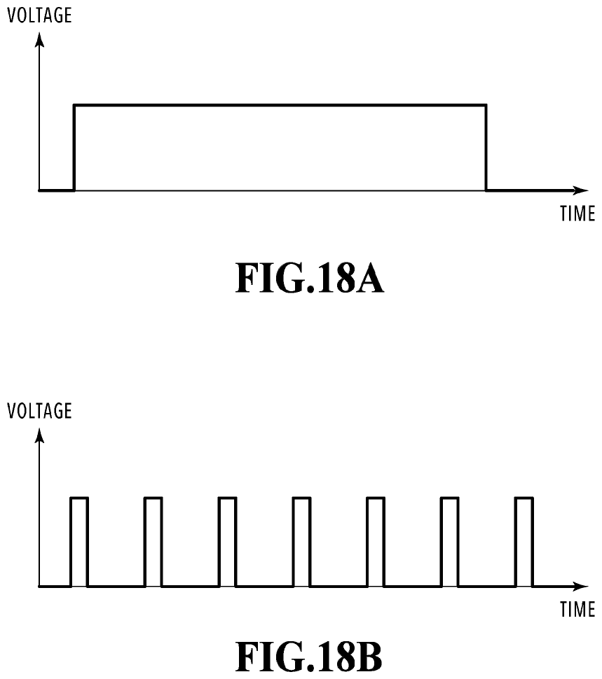

Next, the fourth embodiment of the present invention is described with reference to FIGS. 18A and 18B. FIGS. 18A and 18B are schematic diagrams illustrating waveforms of the voltage applied between the cavitation resistance layer 54a and the opposing electrode 54b (see FIG. 7) by the external power supply 130 in the element cleaning.

In the aforementioned embodiments, a continuous DC voltage as illustrated in FIG. 18A is assumed to be applied consecutively for predetermined time between the cavitation resistance layer 54a and the opposing electrode 54b in the element cleaning. Meanwhile, in this embodiment, an intermittent pulse-shaped DC voltage as illustrated in FIG. 18B is applied between the cavitation resistance layer 54a and the opposing electrode 54b. The CPU 201 (see FIG. 11) in a control device controls the external power supply 130 to apply such a DC voltage.

In the case where the continuous DC voltage is consecutively applied for predetermined time as illustrated in FIG. 18A, the bubbles BL are consecutively generated while the voltage is applied to the cavitation resistance layer 54a. Meanwhile, in the embodiment, the voltage is intermittently applied as illustrated in FIG. 18B and this can reduce a generation rate of the bubbles (volume of the bubbles generated per unit time). Accordingly, in the embodiment, it is possible to appropriately discharge the bubbles BL in the bubbling chambers 23 to the outside without greatly increasing the flow rate of the fluid FL in the element cleaning and suppress the filling of the bubbling chambers 23 with the bubbles BL. For example, in the case where an application duty of the voltage illustrated in FIG. 18A is 100% and an application duty of the voltage illustrated in FIG. 18B is 30%, the generation rate of the bubbles generated by the voltage illustrated in FIG. 18B is 30% the generation rate of the bubbles generated by the voltage illustrated in FIG. 18A. In the case where the bubble generation rate is reduced to 30% as described above, the flow rate of the fluid FL in the print element boards 10 can be reduced. For example, in the case of employing the configuration in which the flow rate of the fluid in the print element boards 10 is adjusted by adjusting the water head between the fluid supply bottle 101 and the fluid collection bottle 102 as in the first embodiment, the heights of the respective bottles in the element cleaning are set as follows in the embodiment:

.H1′=100 mm

.H2′=600 mm.

In this case, the negative pressure applied to the ejection ports 13 is (H1′+H2′)/2=350 mmAq, the differential pressure applied to the fluid supply channel 18 and the fluid collection channel 19 is (H2′−H1′)=500 mmAq, and the flow rate of the fluid FL flowing in the print element boards 10 drops to about 50 mm/s. However, in the embodiment, since the generation rate of the bubbles BL is decreased to 30%, the generated bubbles can be appropriately discharged to the outside of the print element boards 10 even at the flow rate of about 50 mm/s. Accordingly, the filling of the bubbling chambers 23 with the bubbles is suppressed and the kogation can be appropriately removed.

As described above, according to the embodiment, change amounts of the water heads in the height adjustment mechanisms 105 and 106 (a change amount from H1 to H1′ and a change amount from H2 to H2′) can be suppressed to small amounts. Thus, it is possible to reduce the sizes of the height adjustment mechanisms 105 and 106 and also reduce the size of the entire apparatus.

### Other Embodiments

The present invention can be applied to a fluid ejection apparatus employing a configuration in which the fluid ejection apparatus executes an ejection operation of ejecting fluid from ejection ports and a cleaning operation of removing foreign substances such as kogation from ejection elements while causing the fluid to flow in a flow channel formed in a fluid ejection head. Accordingly, in the present invention, a process performed on the fluid collected from the fluid ejection head is not limited to a particular process. Specifically, the present invention is not limited to a fluid ejection apparatus employing a circulation method in which the fluid collected from the fluid ejection head is circulated again to the fluid ejection head as in the aforementioned embodiments. For example, the configuration may be such that the fluid collected from the fluid ejection head is simply held in a container and a container on the supply side is replaced with the collection container at the point where the container on the supply side becomes empty.

Moreover, although the aforementioned embodiments are described by using the full line printing apparatus as an example, the present invention can be also applied to a so-called serial printing apparatus that performs scanning of the fluid ejection head on the print medium. Moreover, the present invention can be applied not only to the printing apparatus but also to other fluid ejection apparatuses.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2020-157214, filed Sep. 18, 2020 which is hereby incorporated by reference wherein in its entirety.

What is claimed is:

1. A fluid ejection apparatus comprising:
a fluid ejection head including a flow channel that extends from a fluid supply port to a fluid collection port, an ejection port that is used to eject fluid, and an ejection element that heats the fluid flowing into the flow channel to eject the fluid from the ejection port;
a cleaning unit that performs a cleaning process by means of electrochemical reaction between the fluid and a fluid contact portion of the ejection element;
a fluid flow unit that causes the fluid to flow from the fluid supply port to the fluid collection port of the flow channel in the cleaning process and an ejection operation of ejecting the fluid from the ejection port; and
a flow rate control unit that adjusts a flow rate of the fluid flowing in the flow channel to a first flow rate during the ejection operation and adjusts the flow rate of the fluid flowing in the flow channel to a second flow rate higher than the first flow rate at least during the cleaning process.

2. The fluid ejection apparatus according to claim 1, wherein
the fluid flow unit includes a fluid supply container communicating with the fluid supply port and a fluid collection container communicating with the fluid collection port, and
the flow rate control unit includes an adjustment mechanism that adjust at least one of a fluid surface of the fluid stored in the fluid supply container and a fluid surface of the fluid stored in the fluid collection container.

3. The fluid ejection apparatus according to claim 2, wherein the adjustment mechanism adjusts at least one of a first distance that is a distance between the ejection port and the fluid surface of the fluid stored in the fluid supply container in a direction of gravity and a second distance that is a distance between the ejection port and the fluid surface of the fluid stored in the fluid collection container in the direction of gravity.

4. The fluid ejection apparatus according to claim 3, wherein the flow rate of the fluid flowing in the flow channel is increased by increasing a difference between the first distance and the second distance.

5. The fluid ejection apparatus according to claim 1, wherein the flow rate control unit adjusts viscosity of the fluid by adjusting temperature of the fluid supplied to the flow channel.

6. The fluid ejection apparatus according to claim 1, wherein the flow rate control unit includes a pressure adjustment mechanism that controls pressure of the fluid supplied to the flow channel.

7. The fluid ejection apparatus according to claim 1, wherein the flow rate control unit maintains the flow rate of the fluid flowing in the flow channel at the second flow rate for predetermined time from completion of the cleaning process.

8. The fluid ejection apparatus according to claim 2, wherein
the fluid flow unit includes a circulation flow channel that allows the fluid flowing out from the fluid collection port of the fluid ejection head to return to the fluid supply port of the fluid ejection head, and
the circulation flow channel includes a return flow channel that allows the fluid stored in the fluid collection container to return to the fluid supply container, and is configured to cause the fluid stored in the fluid supply container to flow through the fluid ejection head, the fluid collection container, and the return flow channel and return to the fluid supply container.

9. The fluid ejection apparatus according to claim 1, wherein
the fluid flow unit includes a circulation flow channel that allows the fluid flowing out from the fluid collection port of the fluid ejection head to return to the fluid supply port of the fluid ejection head, and
the circulation flow channel includes a fluid supply collection container that communicates with the fluid supply port and the fluid collection port of the fluid ejection head, and is configured to cause the fluid stored in the fluid supply collection container to flow through the fluid ejection head and return to the fluid supply collection container.

10. The fluid ejection apparatus according to claim 1, wherein
the ejection element includes a heating layer that generates thermal energy used to heat the fluid flowing into the flow channel and eject the fluid from the ejection port and a coating layer that covers the heating layer and comes into contact with the fluid, and
the cleaning unit performs the cleaning process by applying voltage between the coating layer and an opposing electrode, provided in the flow channel and separated from the coating layer, to cause electrochemical reaction to occur between the coating layer and the fluid and cause the fluid contact portion of the coating layer to dissolve into the fluid.

11. The fluid ejection apparatus according to claim 10, wherein the cleaning unit intermittently applies voltage between the coating layer and the opposing electrode.

12. A method of controlling a fluid ejection apparatus including:
a fluid ejection head including a flow channel that allows a fluid flowing in from a fluid supply port to flow out from a fluid collection port, an ejection port that is used to eject part of the fluid flowing into the flow channel, and an ejection element that heats the fluid flowing into the flow channel to eject the fluid from the ejection port;
a cleaning unit that performs a cleaning process by means of electrochemical reaction between the fluid and a fluid contact portion of the ejection element; and
the fluid flow unit that causes the fluid to flow from the fluid supply port to the fluid collection port of the flow channel, the method comprising the steps of:
adjusting a flow rate of the fluid flowing in the flow channel to a first flow rate in an ejection operation of ejecting the fluid from the ejection port; and
stopping the ejection operation in the cleaning process and adjusting the flow rate of the fluid flowing in the flow channel to a second flow rate higher than the flow rate of the fluid flowing in the flow channel during the ejection operation.

13. The method of controlling the fluid ejection apparatus according to claim 12, wherein the flow rate of the fluid flowing in the flow channel is maintained at the second flow rate for predetermined time from completion of the cleaning process.

14. The method of controlling the fluid ejection apparatus according to claim 13, further comprising a step of returning the flow rate of the fluid flowing in the flow channel from the second flow rate to the first flow rate after the predetermined time elapses from the completion of the cleaning process.
